(19) United States
(12) Patent Application Publication
(10) Pub. No.: US 2016/0078705 A1
(43) Pub. Date: Mar. 17, 2016

(54) COMPUTER-NETWORK IMPLEMENTED SYSTEM AND METHOD FOR MEASURING INTEREST OF USERS WHO ARE PRESENTED WITH DESCRIPTION INFORMATION OF CANDIDATES OF A VOTING EVENT

(71) Applicant: Tony Chien-Yu Lin, Taoyuan City (TW)

(72) Inventor: Tony Chien-Yu Lin, Taoyuan City (TW)

(21) Appl. No.: 14/941,697

(22) Filed: Nov. 16, 2015

Related U.S. Application Data
(63) Continuation-in-part of application No. 13/827,524, filed on Mar. 14, 2013.
(60) Provisional application No. 61/615,690, filed on Mar. 26, 2012.

(51) Int. Cl. G07C 13/00

(52) U.S. Cl. CPC G07C 13/00

(57) ABSTRACT

A computer-network implemented system is provided for performing a method for measuring interest of users of client devices who are presented with description information of candidates of a voting even. The method includes: providing, to the client devices, candidate data containing the description information; receiving, from the client devices, voting data indicating inputs to vote for the candidates; selecting a winning candidate according to numbers of inputs to vote indicated by the voting data; providing reward data to the client devices from which the voting data corresponding to the winning candidate were received, the reward data including beneficial information associated with the winning candidate.

### CROSS-REFERENCE TO RELATED APPLICATION

This application is a continuation-in-part application of U.S. patent application Ser. No. 13/827,524 filed on Mar. 14, 2013, claiming priority from U.S. Provisional Application No. 61/615690, filed on Mar. 26, 2012.

### BACKGROUND OF THE INVENTION

1. Field of the Invention

The present invention relates to a method and system for measuring interest of users who are presented with description information of candidates of a voting event.

2. Description of the Related Art

Nowadays, more and more people rely on the Internet whenever they need information on such as products and services. Although most online shopping platforms, discussion forums, and information sources for such needs nowadays generally implement a mechanism through which users may post comments, rate, and discuss about a product and/or service, most users may be reluctant to make use of such a mechanism (e.g., a voting event) because such activities are generally time-consuming and non-rewarding.

Generally, in the context of online shopping, after each transaction, a conventional post-transaction survey may be conducted in order to ascertain reasons of purchase. For example, Tietzen et al. (U.S. 2011/0112897) discloses a conventional post-transaction survey intended for establishing a link between the transaction and any earlier user activity. Feedback information thus collected can be presented in a number of forms for review by the merchant or supplier in order to confirm the transaction behaviour. Tietzen further teaches providing an incentive (e.g., discount) to the user after the occurrence of the transaction. In one particular embodiment, the incentive is provided upon user completion of the post-transaction survey. Depending on user feedback (e.g., perceived quality of service), different incentives may be provided.

A result of such a survey may provide the merchant with a better understanding of user behaviour and preference, allowing the merchant to offer future products or services that are more popular. However, because such a survey is completed after the occurrence of a transaction, the survey plays no role in the improvement of user satisfaction and total sales in respect of the merchandise (or service) for which the survey is conducted. In an exemplary scenario, tickets for a non-recurring event are to be offered with one of a number of alternative gifts, some of which are more popular than the others. If a less popular one of the gifts is selected for association with the tickets due to poor understanding of user preference, fewer sales may be achieved and post-transaction surveys may indicate a causal link between user dissatisfaction and the selected gift.

### SUMMARY OF THE INVENTION

It is one object of the present invention to overcome, or ameliorate, one or more of the disadvantages of the prior art.

According to one aspect, there is provided a computer-network implemented system for measuring interest of users of client devices who are presented with description information of candidates of a voting event. The system comprises: a data storage device storing the description information of the candidates; a network interface to transceive electronic signals with the client devices of the users; and at least one processor coupled to the data storage device and the network interface.

The at least one processor is programmed to: provide, via the network interface to the client devices, electronic signals representing candidate data that contains at least a portion of the description information of the candidates; receive, via the network interface from each of the client devices, electronic signals representing voting data that indicates an input to vote for one of the candidates; upon detecting an ending condition of the voting event, select a winning candidate according to numbers of inputs to vote indicated by the voting data and corresponding to the candidates; and provide electronic signals representing reward data via the network interface to the client devices from which the electronic signals representing voting data that correspond to the winning candidate were received, the reward data including beneficial information associated with the winning candidate.

According to another aspect, there is provided a computer-network implemented method for measuring interest of users of client devices who are presented with description information of candidates of a voting event. The method comprises: providing, via a computer network to the client devices, electronic signals representing candidate data that contains at least a portion of the description information of the candidates;

receiving, via the computer network from each of the client devices, electronic signals representing voting data that indicates an input to vote for one of the candidates; upon detecting an ending condition of the voting event, selecting a winning candidate according to numbers of inputs to vote indicated by the voting data and corresponding to the candidates; and providing electronic signals representing reward data via the computer network to the client devices from which the electronic signals representing voting data that correspond to the winning candidate were received, the reward data including beneficial information associated with the winning candidate.

According to yet another aspect, there is provided a computer-network implemented system for measuring interest of users who are presented with description information corresponding to candidates. Each of the users has a corresponding user profile. The system comprises: a data storage device storing the user profiles of the users and the description information of the candidates; a network interface to transceive signals with client devices of the users; and at least one processor coupled to the data storage device and the network interface.

The at least one processor is programmed to: provide, via the network interface, a webpage to web browsers of the client devices of the users, the webpage containing at least a portion of the description information of the candidates who are subjects of a voting event being hosted by the system, the voting event being open to the users for participation; monitor, receive, and store in the data storage device, electronic signals from the web browsers of the client devices of the users, each of the electronic signals representing an input to vote for one of the candidates of the voting event and being linked to the user profile of a corresponding one of the users; detect an ending condition of the voting event; select, after detecting the ending condition, a winning candidate according to numbers of inputs to vote corresponding to the candidates and represented by the electronic signals received from the client devices of the users and stored in the data storage device; determine the users who voted for the winning candidate; and generate a reward and provide, via the network interface, the reward to the users who voted for the winning candidate, the reward including beneficial information associated with the winning candidate.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart showing steps of the preferred embodiment of a method for measuring interest of users who are presented with description information of candidates of a voting event, according to the present invention;

FIG. 2 is a diagram showing computer components typical of a server device for hosting a commercial website on the Internet for access by client devices;

FIG. 3 is a diagram showing an exemplary webpage hosted by the server device in performing one embodiment of the method of the present invention; and

FIG. 4 is a diagram showing an exemplary webpage hosted by the server device in performing another embodiment of the method of the present invention.

### DETAILED DESCRIPTION OF THE PREFERRED EMBODIMENTS

Before the present invention is described in greater detail, it should be noted that like elements are denoted by the same reference numerals throughout the disclosure.

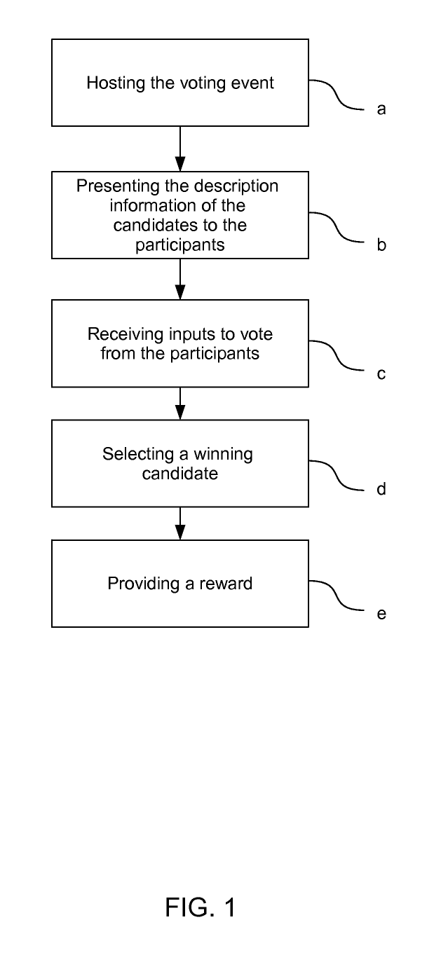

Shown in FIG. 1 is the preferred embodiment of a method for measuring interest of users who are presented with description information of candidates of a voting event, according to the present invention. In this embodiment, the voting event is associated with first and second candidates (e.g., products or services offered by suppliers), each of which is associated with description information (e.g., commercial promotion information, free giveaway information, an image, a video, and combinations thereof) and beneficial information (i.e., information that enables the participants to avail of the candidates). In other embodiments, the voting event may be associated with more candidates.

The method is to be performed preferably by a server device including a member database (e.g., a user database) that includes a plurality of member profiles (e.g., user profiles) corresponding to the participants (e.g., users) of the voting event, respectively. Each of the member profiles includes such as reward points, member pictures, member statistic information, and description associated with the corresponding one of the participants. The participants maybe connected via a network (e.g., the Internet) to the server device through various client devices such as smartphones, personal computers, portable computers, and tablet personal computers. It should be noted that, in other embodiments, the server device may be operatively associated with an external member database instead of an internal member database. Preferably, the server device is a computing device with sufficient processing power to host a commercial website.

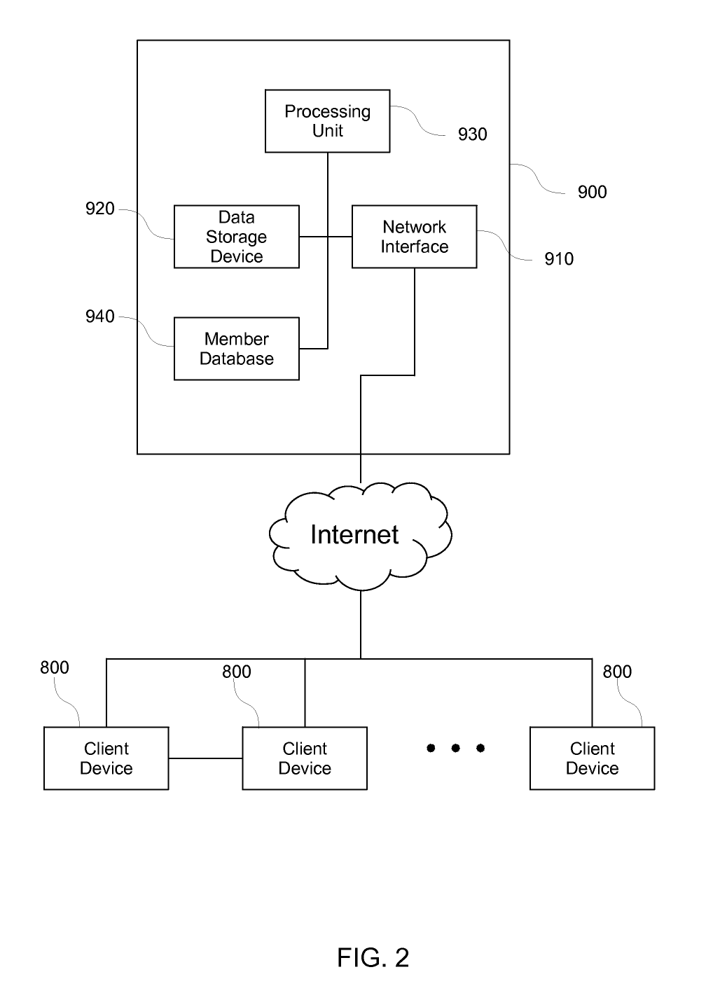

Shown in FIG. 2 is an exemplary typical configuration of such a computing device 900. In the configuration, the computing device 900 further includes typical computer components, such as a network interface 910, a data storage device 920 and a processing unit 930 (e.g., a processor), in additional to the member database 940. The processing unit 390 is operatively associated with the network interface 910 and the storage device 920. The network interface 910 is operatively associated with the network (e.g. the Internet), to which the client devices 800 are operatively associated. In other embodiments, the computing device 900 may be arranged such that the data storage device 920 is an external storage device external to the computing device 900. The data storage device 920 stores the description information and the beneficial information of the candidates. In this embodiment, the data storage devices 920 further stores instructions and information for enabling the processing unit 930 to generate hypertext markup language (HTML) webpages (or the likes). However, in other embodiments, the processing unit 930 may be otherwise configured or programmed to perform the same or similar functions.

The storage device 920 is configured to store therein computer-executable instructions for causing the processing unit 930 to perform the method of the present invention. It is worth noting that the processing unit 930 maybe otherwise programmed or configured to perform the method.

In performing the method, the processing unit 930 of the server device 900 communicates via the network interface 910 through the network with processing units of the client devices 800 (not shown) operated by the participants. Some of the client devices 800 may be installed with, for example, a proprietary software application for communicating with the website hosted by the server device. Such software application may be a smartphone software application.

Operations of the processing unit 930 in performing the method are described hereinafter.

In step a), the processing unit 930 hosts the voting event in the form of a webpage for viewing and participation by the participants through the client devices 800 via the network. Specifically, the processor unit 930 generates from the data storage device 920 webpage data including candidate data. The webpage data represents the webpage to be shown on the client devices 800. The candidate data represents the description information of the candidates that is stored in the data storage device 920 and that is to be shown on the webpage represented by the webpage data. It should be noted that, in other embodiments, the voting event may be hosted in any form other than a website.

In step b), the processing unit 930 presents the webpage via the network interface 910 to the participants (e.g., users). More specifically, the processor unit 930 provides electronic signals representing the webpage data via the network interface 910 through the network to the client devices 800.

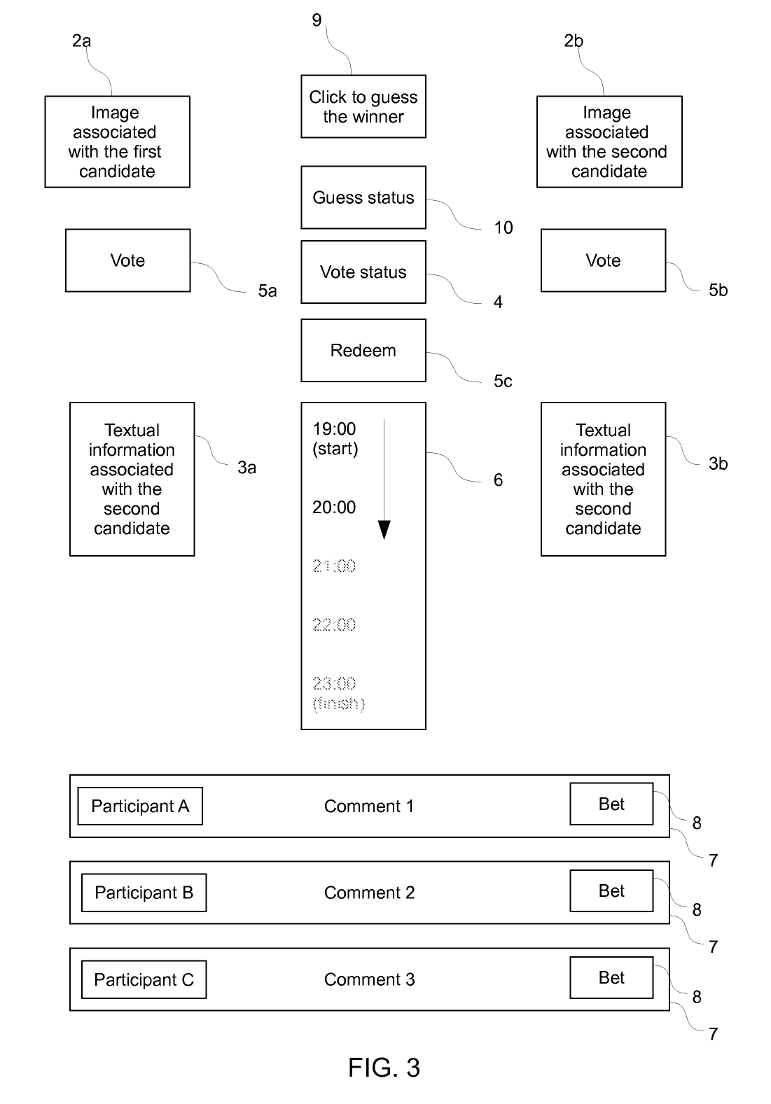

Shown in FIG. 3 is an exemplary webpage rendered by the client devices 800 from the webpage data received thereby. The exemplary webpage shows information specific to the candidates and rendered from the candidate data, including first and second images 2a, 2b and first and second boxes 3a, 3b. The first and second images 2a, 2b correspond respectively to the first and second candidates. The first and second boxes 3a, 3b show textual information corresponding respectively to the first and second candidates. The textual information may include such as brands, products, prices, dates, availability, addresses, and phone numbers. However, presentation of the description information is not limited to such, and may be otherwise implemented in other embodiments. In step c), the server device 900 receives, via the network interface 910 from the participants (e.g., users), inputs to vote. Each of the inputs corresponds to one of the candidates. More specifically, the processing unit 930 receives, via the network interface 910 through the network from each of the client devices 800, electronic signals representing voting data. The voting data of each client device 800 is indicative of an input to vote for one of the candidates.

In the exemplary webpage of FIG. 3, each of the participants may provide, via their respective client device 800, the input to vote for one of the first and second candidates by clicking a corresponding one of first and second vote-buttons 5a, 5b of the webpage. In this embodiment, the exemplary webpage shows a vote status of the voting event in a vote-status region 4 during a predetermined count-down time be fore the voting event ends. The count-down time may range from 0 second to the duration of the voting event. In particular, the vote status includes, but is not limited to, a total number of the inputs to vote received by the server device, and, for each of the first and second candidates, a total number of the inputs to vote for the candidate. The vote-status region 4 may be omitted (e.g., hidden) in other embodiments. Furthermore, in some embodiments, each of the participants may redeem a predetermined number of the reward points for casting additional votes. The reward points may be purchased, or earned in such as the voting event, and may be redeemed for various benefits, such as online game time and discount coupons or vouchers.

In step d), the server device 900 selects a winning candidate according to numbers of inputs to vote corresponding to the candidates and received from the participants. More specifically, upon detecting an ending condition of the voting event, the processing unit 930 selects a winning candidate from the first and second candidates according to numbers of inputs to vote corresponding to the candidates. In the example of FIG. 3, the ending condition is a system time of the server device 900 corresponding to a predetermined event ending time (e.g., 23:00).

In this embodiment of two candidates, the winning candidate is the candidate to which a larger number of the inputs to vote received from the participants correspond when the voting event ends. In embodiments with more than two candidates, the winning candidate is the candidate to which a largest number of the inputs to vote received from the participants correspond when the voting event ends. Selection of the winning candidate is not limited to such, and may be otherwise implemented in other embodiments. For example, in a scenario involving three candidates, the voting event may be arranged such that the winning candidate is the candidate to which a smallest number of the inputs to vote correspond.

In step e), the server device 900 provides, via the network interface 910, a reward to the participants from which the inputs to vote corresponding to the winning candidate were received (hereinafter referred to as the winning participants). More specifically, the processing unit 930 provides electronic signals representing reward data via the network interface 910 through the network to the client devices 800 from which the electronic signals representing voting data that corresponds to the winning candidate are received. The reward data includes the beneficial information stored in the data storage device 920 and associated with the winning candidate.

The winning candidates may be further rewarded. For example, the reward may further include a predetermined number of reward points to be associated to the member profile of each of the winning participants in addition to the beneficial information. The beneficial information may include access information for coupons or vouchers corresponding to the winning candidate, such that the winning participants are able to avail of the winning candidate. Under circumstances where the winning candidate may be availed of by only a limited number of the winning participants, the winning participants that voted for the winning candidate at earlier times maybe assigned higher priorities to avail of the winning candidate. In other embodiments, the server device 900 may be configured to provide more reward points to the winning participants from which the inputs to vote corresponding to the winning candidate were received at earlier times. As mentioned hereinabove, the reward points may be purchased, or earned through voting for the winning candidate. Other examples for which the reward points maybe redeemed include special profile icons and a higher membership status. However, applications of the reward points are not limited to such.

In this embodiment, the server device 900 is configured to present the remaining time of the voting event in a time-status region 6 of the webpage, and to present respectively a plurality of comments received from some of the participants in a plurality of comment-regions 7 of the webpage. In the example of FIG. 3, the voting event is shown to start at 19:00 and to finish at 23:00. Preferably, the webpage may provide a mechanism through which the participants may bet against each other as to which of the candidates will be the winning candidate. Specifically, each of the comment-regions 7 includes a bet-button 8 clickable by any of the participants to trigger a bet of user-determined reward points (or system-determined reward points) with the participant, to which the comment-region 7 corresponds, as to which of the candidates will be the winning candidate. Such a function may be useful for encouraging participation of the participants when disagreements exist among preferences of the participants for the candidates. Ina modification of the first preferred embodiment, the server device 900 is further configured to show a guess-button 9 in the webpage clickable by the participants to register respective guesses as to which of the candidates will be the winning candidate, as well as a guess-status region 10 preferably showing statistical information corresponding to the guesses. In comparison with the vote-status region 4, information shown in the guess-status region 10 merely serves a reference upon which the participants may independently determine which of the candidates will be the winning candidate. However, participants that clicked the guess-button 9 to register guesses may still be rewarded with a different reward.

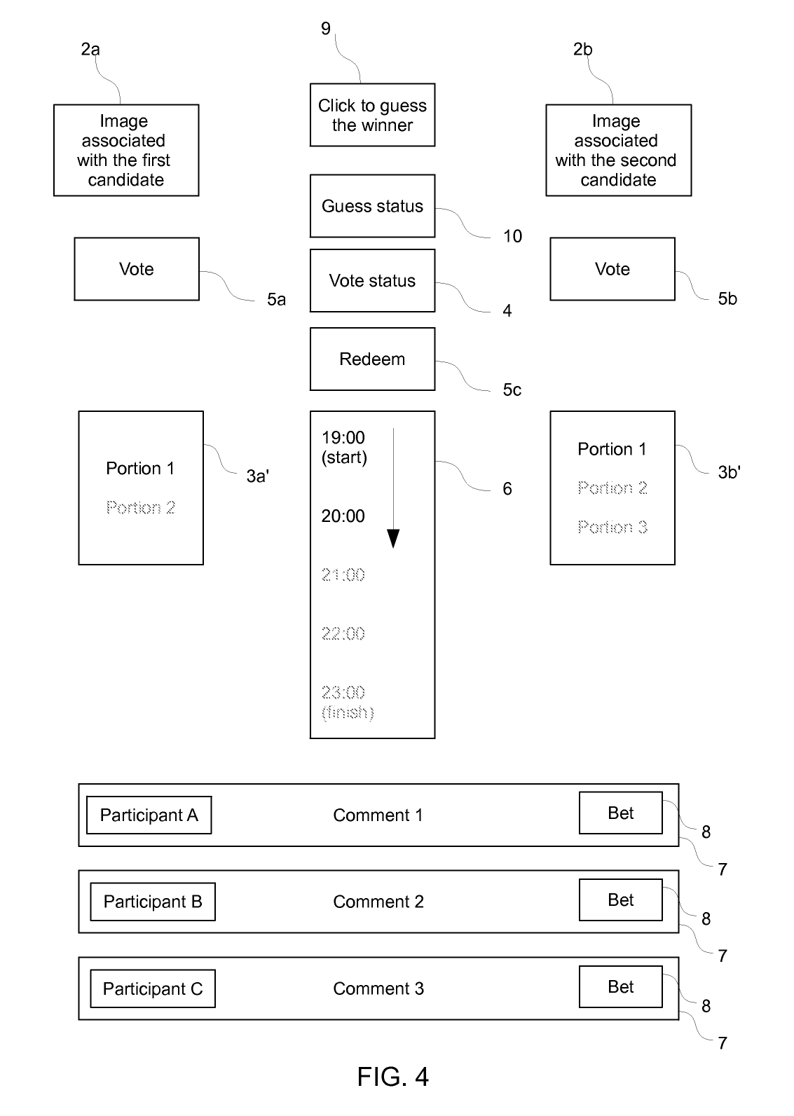

Referring to FIG. 4, the difference between the first and second preferred embodiments resides in that, in the second preferred embodiment, the description information of each of the candidates is divided into a respective number of portions for presentation to the participants at scheduled times (see boxes 3a′, 3b′). In this embodiment, the description information of the first candidate is divided into first and second portions for presentation to the participants at 19:00 and 21:00, respectively. The description information of the second candidate is divided into first, second, and third portions for presentation to the participants at 19:00, 20:00, and 21:00, respectively. The number of portions into which the description information is divided, and the times at which the portions of the description information are presented, are not limited to such. As mentioned hereinabove, the server device 900 may be configured to provide more reward points to the winning participants from which the inputs to vote were received at earlier times. For example, if the first candidate is the winning candidate, the server device 900 may be configured to provide more reward points to the winning participants from which the inputs to vote were received before the second portion of the description information of the first candidate is presented compared to the winning participants from which the inputs to vote were received after the second portion of the description information of the first candidate is presented. Thus, the participants are encouraged to register their votes with the server device 900 at earlier times.

Examples of the first and second candidates are described hereinafter. In a first example, the first and second candidates correspond to products from the same supplier. In a second example, the first and second candidates correspond to products from different suppliers. In a third example, the first and second candidates correspond to services from the same providers. In a fourth example, the first and second candidates correspond to services from different providers. It is to be noted that the first and second candidates are not limited to such.

Furthermore, under circumstances where the winning candidate may be availed of by other than the winning participants, non-winning participants and non-participating spectators of the voting event may also avail of the winning candidate. For example, in step e), the server device 900 may further presents the beneficial information to the non-winning participants and the non-participating spectators, in addition to the winning participants, after a predetermined delay time has elapsed. In addition, under circumstances where the voting event results in a draw, both the first and second candidates maybe availed of by the participants. Moreover, in other embodiments, the candidates may include more than two candidates. Throughout the voting event, statistical information may be gathered for analysis.

In another modification, the server device 900 may, in step e), further show a redeem-button 5c in the webpage that is clickable only by each of the participants and the spectators who may avail of the winning candidate so as to generate a corresponding entry in an offer-redemption database associated with the winning participant. The entries in the offer-redemption database maybe outputted for provision to the supplier (or the providers) of the winning candidate for reference during redemption of the product or the service to which the winning candidate corresponds.

Unlike the conventional post-transaction survey, the voting event according to the present invention is hosted before the occurrence of any transact ion. In other words, the voting event is a pre-transaction voting event. If the method of the present invention is employed in a scenario similar to the abovementioned scenario of ticket sale, by virtue of the pre-transaction nature, user preference for the gift to be associated can be identified prior to transaction and a more popular one of the alternative gifts can thus be identified for association with the tickets, resulting in more sales and higher user satisfaction.

It should be noted that the computing device may also take other forms, provided that the computing device is capable of performing the method of the present invention.

In summary, by performing the method of the present invention, the server device 900 conducts a voting event (i.e., a pre-transaction voting event) for measuring the level of user interest in each of the candidates associated with the voting event, such that a more popular one of the candidates (i.e. goods, services or combinations thereof) may be identified and made available for purchase or redemption by at least the winning participants, thereby improving sales and user satisfaction.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A computer-network implemented system for measuring interest of users of client devices who are presented with description information of candidates of a voting event, the system comprising:
a data storage device storing the description information of the candidates;
a network interface to transceive electronic signals with the client devices of the users; and
at least one processor coupled to the data storage device and the network interface, the at least one processor being programmed to:
provide, via the network interface to the client devices, electronic signals representing candidate data that contains at least a portion of the description information of the candidates;
receive, via the network interface from each of the client devices, electronic signals representing voting data that indicates an input to vote for one of the candidates;
upon detecting an ending condition of the voting event, select a winning candidate according to numbers of inputs to vote indicated by the voting data and corresponding to the candidates; and
provide electronic signals representing reward data via the network interface to the client devices from which the electronic signals representing voting data that correspond to the winning candidate were received, the reward data including beneficial information associated with the winning candidate.

2. The system as claimed in claim 1, the candidates being products or services offered by suppliers, wherein the beneficial information enables the users who received the reward data to avail of the winning candidate.

3. The system as claimed in claim 2, wherein the beneficial information includes access information for one of a coupon and a voucher corresponding to the winning candidate.

4. The system as claimed in claim 1, wherein the winning candidate is the candidate who received a larger number of the inputs to vote from the users.

5. The system as claimed in claim 1, the candidates including more than two candidates, wherein the winning candidate is the candidate who received a largest number of the inputs to vote from the users.

6. The system as claimed in claim 1, wherein the at least one processor is further programmed to vary an amount of the description information contained in the candidate data at predetermined times of the voting event.

7. The system as claimed in claim 1, wherein the at least one processor is further programmed to provide, via the network interface, the reward data to the client devices from which the electronic signals representing voting data that correspond to inputs to vote for a non-winning candidate were received.

8. A computer-network implemented method for measuring interest of users of client devices who are presented with description information of candidates of a voting event, the method comprising:
providing, via a computer network to the client devices, electronic signals representing candidate data that contains at least a portion of the description information of the candidates;
receiving, via the computer network from each of the client devices, electronic signals representing voting data that indicates an input to vote for one of the candidates;
upon detecting an ending condition of the voting event, selecting a winning candidate according to numbers of inputs to vote indicated by the voting data and corresponding to the candidates; and
providing electronic signals representing reward data via the computer network to the client devices from which the electronic signals representing voting data that correspond to the winning candidate were received, the reward data including beneficial information associated with the winning candidate.

9. The method as claimed in claim 8, the candidates being products or services offered by suppliers, wherein the beneficial information enables the users who received the reward data to avail of the winning candidate.

10. The method as claimed in claim 9, wherein the beneficial information includes access information for one of a coupon and a voucher corresponding to the winning candidate.

11. The method as claimed in claim 8, wherein the winning candidate is the candidate who received a larger number of the inputs to vote from the users.

12. The method as claimed in claim 8, the candidates including more than two candidates, wherein the winning candidate is the candidate who received a largest number of the inputs to vote from the users.

13. The method as claimed in claim 8, further comprising varying an amount of the description information contained in the candidate data at predetermined times of the voting event.

14. The method as claimed in claim 8, further comprising providing, via the computer network, the reward data to the client devices from which the electronic signals representing voting data that correspond to inputs to vote for a non-winning candidate were received.
